(19) United States
(12) Patent Application Publication
(10) Pub. No.: US 2025/0378105 A1
(43) Pub. Date: Dec. 11, 2025

(54) SYSTEMS AND METHODS FOR DATA EXTRACTION

(71) Applicant: Optum, Inc., Minnetonka, MN (US)

(72) Inventors: Rahul AGGARWAL, Bengaluru (IN); Ankit KINDRA, Delhi (IN); Vibhor DAWAR, Gurgaon (IN); Kartik Krishna BHARDWAJ, Faridabad (IN); Saurabh BHARGAVA, Eden Prairie, MN (US); Harshit GUPTA, Shamsabad (IN)

(21) Appl. No.: 18/736,780

(22) Filed: Jun. 7, 2024

(51) Int. Cl. G06F 16/35

(52) U.S. Cl. CPC G06F 16/355

(57) ABSTRACT

Systems and methods are disclosed for data extraction. One or more processors may receive an interaction data object containing text data and generate an intent data object with high-level and granular intent indicators using a trained intent classification machine-learning model. The processors may also generate a subject data object using a trained subject classification machine-learning model. The processors may select a target model bundle from multiple bundles based on the granular intent indicator, and the target bundle contains machine-learning models trained to extract signals from the text data. By applying the interaction data object to the target model bundle, the processors may generate a signal data object with signal indicators. The processors may modify a curated data object by changing data entries based on the generated intent, subject, or signal data objects.

### TECHNICAL FIELD

The present disclosure relates generally to the technical field of data extraction. More particularly, the present disclosure relates to systems and methods for using machine learning and/or rule-based techniques for extracting granular information from conversation data.

### BACKGROUND

In the context of data-driven insights extraction, the challenge of deriving accurate insights from interaction data between a user and a system becomes particularly pronounced when dealing with complex or nuanced information. Traditional methods of information extraction often fall short, leading to a prolonged process of trying to accurately extract and interpret the data. This process may involve repeated data collection, misinterpretation of data, and delays in implementing suitable actions based on the extracted insights. Such challenges result in inefficient use of resources and potential missteps due to incorrect data interpretation, impacting the overall effectiveness of the data extraction process.

Existing methodologies for extracting complex or nuanced information from interaction data face significant hurdles. Current systems and methods are reactive, primarily generating insights after an interaction has concluded, which stifles the potential for preemptive action. Additionally, there is a pronounced delay in insight extraction, as the conversion of raw interaction data into a structured format necessary for analysis can extend over weeks or months. This lag not only slows the decision-making process but also exacerbates the ‘cold start’ dilemma, where the absence of historical data hinders the accurate assessment of new or unique scenarios. Additionally, the prevailing methodologies are prone to selection bias, disproportionately focusing on data that is readily available, thereby neglecting or delaying attention to data that may be more complex or time-consuming to process. This bias affects the subsequent application of these insights, potentially leading to skewed or incomplete interpretations. The subjectivity inherent in these processes further complicates the landscape; intermediaries who interpret the raw data can introduce their biases, affecting the neutrality and accuracy of the insights extracted. Lastly, the risk of information loss looms large, as the existing systems, in their bid to categorize and process vast datasets, might overlook or discard nuances and subtleties contained within the interaction data, leading to an incomplete or distorted understanding of user needs and behaviors. This leads to inefficiencies and delays in the application of data-driven decisions.

This disclosure is directed to addressing challenges such as those mentioned above. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

The present disclosure addresses the technical problem(s) described above or elsewhere in the present disclosure and improves the state of data incident response techniques.

In some aspects, the techniques described herein relate to a computer-implemented method including; receiving, by one or more processors, an interaction data object including text data related to one or more interaction; generating, by the one or more processors, an intent data object that includes a high level intent indicator and a granular intent indicator for the one or more interaction by applying the interaction data object to a trained intent classification machine-learning model; generating, by the one or more processors, a subject data object for the one or more interaction by applying the interaction data object to a trained subject classification machine-learning model, the subject data object including a subject indicator; selecting, by the one or more processors, a target model bundle from a plurality of model bundles based on the granular intent indicator, the target model bundle including a plurality of machine-learning models trained to extract one or more signals from the text data; generating, by the one or more processors, a signal data object by applying the interaction data object to the target model bundle, the signal data object including a plurality of signal indicators; and modifying, by the one or more processors, a curated data object by changing one or more data entry based on one or more of the generated intent data object, the generated subject data object, and the generated signal data object.

In some aspects, the techniques described herein relate to a system including memory and one or more processors communicatively coupled to the memory, the one or more processors configured to: receive an interaction data object including text data related to one or more interactions; generate an intent data object that includes a high level intent indicator and a granular intent indicator for the one or more interactions by applying the interaction data object to a trained intent classification machine-learning model; generate a subject data object for the one or more interactions by applying the interaction data object to a trained subject classification machine-learning model, the subject data object including a subject indicator; select a target model bundle from a plurality of model bundles based on the granular intent indicator, the target model bundle including a plurality of machine-learning models trained to extract one or more signals from the text data; generate a signal data object by applying the interaction data object to the target model bundle, the signal data object including a plurality of signal indicators; and modify a curated data object by changing one or more data entries based on one or more of the generated intent data object, the generated subject data object, or the generated signal data object.

In some aspects, the techniques described herein relate to one or more non-transitory computer-readable storage media including instructions that, when executed by one or more processors, cause the one or more processors to: receive an interaction data object including text data related to one or more interactions; generate an intent data object that includes a high level intent indicator and a granular intent indicator for the one or more interactions by applying the interaction data object to a trained intent classification machine-learning model; generate a subject data object for the one or more interactions by applying the interaction data object to a trained subject classification machine-learning model, the subject data object including a subject indicator; select a target model bundle from a plurality of model bundles based on the granular intent indicator, the target model bundle including a plurality of machine-learning models trained to extract one or more signals from the text data; generate a signal data object by applying the interaction data object to the target model bundle, the signal data object including a plurality of signal indicators; and modify a curated data object by changing one or more data entries based on one or more of the generated intent data object, the generated subject data object, or the generated signal data object.

It is to be understood that both the foregoing general description and the following detailed description are example and explanatory only and are not restrictive of the detailed embodiments, as claimed.

### BRIEF DESCRIPTION OF THE DRAWINGS

The accompanying drawings, which are incorporated in and constitute a part of this specification, illustrate various example embodiments and together with the description, serve to explain the principles of the disclosed embodiments.

FIG. 1A is a diagram showing an example of a system environment, according to some embodiments of the disclosure.

FIG. 1B is a diagram of example components of a signal extraction platform, according to some embodiments of the disclosure.

FIG. 1C is a diagram of example components of a data enhancement module, according to some embodiments of the disclosure.

FIG. 1D is a diagram of example components of a model bundle modules, according to some embodiments of the disclosure.

FIG. 2 is a flowchart showing a method for data extraction, according to some embodiments of the disclosure.

FIG. 3 illustrates a data object, according to some embodiments of the disclosure.

FIG. 4 illustrates an interaction data object and a signal data object, according to some embodiments of the disclosure.

FIG. 5 shows an example machine-learning training flow chart, according to some embodiments of the disclosure.

FIG. 6 illustrates an implementation of a computer system that executes techniques presented herein, according to some embodiments of the disclosure.

### DETAILED DESCRIPTION

The present disclosure pertains to the technical field of data extraction. This disclosure encompasses techniques for extracting data based on user interactions. Specifically, it introduces systems and methods to extract data signals from interaction data by leveraging machine learning and rules-based approaches.

Traditional approaches in signal extraction are oftentimes reactive, only utilizing data that has been generated and provided to the system after an interaction has occurred, such as after the administration of one or more services and the resulting data has been processed through standardization platforms that move data between multiple systems before signal extraction is undertaken. Thus, these conventional approaches can be considered as utilizing post-service interaction data. Conventional approaches include collecting and batching data to efficiently process it, but these approaches necessarily delays analysis until a batch is collected.

Thus, while conventional approaches may benefit from economies of scale in batch processing data ex-post-facto, these approaches also commonly result in data lag, where it takes weeks or months for the appropriate signal data extraction system to receive the data in a format which the signals may be extracted and utilized in further analysis. Further, these approaches may suffer from the ‘cold start’ problem, where new users or entities to the system do not have historical data and therefore lack sufficient data to evaluate effectively.

Similarly, these approaches may suffer from availability and selection bias, where more emphasis is placed on users and/or entities where more data is available earlier, which harms users and/or entities participating in earlier systems which do not forward data to the data extraction systems in an expedited manner, which is a bias that then carries forward into different downstream applications and programs. Additionally, current approaches are often highly subjective, relying on system administrative and custodial users to interpret data, which introduces their own perceptions and biases when addressing interactions with users which underlie the user data. Further to subjectivity, this data is often not a direct indication of a perception of the user, which may be useful for signal extraction. Such limitations can lead to inefficiencies, data loss, and reduced effectiveness in signal extraction.

To address concerns such as the above, the present disclosure provides systems and methods aimed at the process of extracting and utilizing pre-service interaction data to identify pertinent signals directly from the data generated during interactions with a system, rather than ex-post-facto processing of batches of data. Leveraging advanced machine-learning techniques, including intent classification and subject classification models, this approach enhances the ability to act on real-time data without sacrificing efficiency of batch processing.

Specifically, the disclosed methods, in embodiments, involve receiving an interaction data object that includes text data from one or more interactions and applying this data to an intent classification machine-learning model. This model is configured to predict both high-level and granular intents based on the text data, thereby facilitating a proactive stance towards data analysis. Upon identifying intents, the system and method proceeds to apply the interaction data object to a subject classification machine-learning model, e.g., conditioned on the satisfaction of predefined criteria by the high-level intent indicators. Subsequently, a selection mechanism is employed to identify a target model bundle from a multitude of machine-learning models. This bundle is configured to extract signals from the interaction data, based on the nuanced understanding provided by the granular intent indicators. The system and method include the generation of a signal data object, inclusive of multiple signal indicators, which is then utilized to modify a curated data object. The signal data object is, in some embodiments, a relational or tabular format, that may be readily utilized by risk engines and other applications without the need for further processing.

This modification is configured to incorporate the insights generated from the intent data object, the subject data object, and the signal data object. Such an approach not only addresses but also effectively mitigates issues such as the overreliance on post-service data, delays in data collection, the cold start problem, and selection bias, ensuring equal access and opportunity in the analysis of interaction data. For example, this approach can be particularly beneficial in healthcare settings, where timely and accurate data analysis is crucial for patient care and decision-making. By processing pre-service data sources such as diagnosis reports, prescription letters, prior authorizations, and claims/reimbursement documents as soon as they are generated, the system can begin extracting valuable signals and insights much earlier, even for new patients with limited historical data. This early data availability, combined with the system's comprehensive data utilization, proactive intent and subject classification, and adaptive model selection, enables healthcare providers to make more informed decisions and deliver better patient care, even in scenarios where the cold start problem would typically hinder analysis and insight generation.

Furthermore, by eliminating the subjectivity introduced by intermediary layers and directly collecting signals from the interactions, the system adopts a user-centric perspective, enhancing the accuracy and relevance of the data collected. This methodology presents a suite of technical advantages across several fields, including data analytics, predictive analytics, artificial intelligence, and data visualization, by implementing a continuous, real-time data collection and analysis framework that is both proactive and inclusive.

The technical improvements and advantages discussed above are not the sole improvements and advantages, and additional technical improvements and advantages will be discussed in the following sections. Further, based on the present disclosure, other technical improvements and advantages will be apparent to one of ordinary skill in the art.

As an illustrative example, consider a practical application wherein an individual, experiencing symptoms suggestive of influenza, engages with a healthcare system through a user chat interface. This scenario unfolds as follows: the individual reports symptoms such as fever, cough, and body aches through the chat interface. This interaction generates a data object that encapsulates the text data related to the described symptoms. The system, equipped with one or more processors, receives this interaction data object and applies it to an intent classification machine-learning model, which is trained to discern the high-level intent (seeking medical advice or diagnosis) and granular intent (understanding if the symptoms align with common illnesses like the flu).

Following the intent classification, the system, upon recognizing the high-level intent as seeking diagnosis, applies the interaction data to a subject classification machine-learning model. This model, trained to identify a subject of the interaction based on the interaction data, determines that the inquiry pertains the individual making the call, e.g., on their own behalf rather than, for example, a parent calling about a child. The granular intent indicator prompts the selection of a targeted model bundle, comprising a suite of machine-learning models adept at extracting signals specific to flu diagnosis from the interaction data.

Upon processing through the target model bundle, a signal data object is produced, containing indicators highly suggestive of the flu. Utilizing this signal data object, the system then modifies a curated data object to reflect the new data, which is then further processed in a manner which generates a diagnosis probability. This triggers an automated intervention protocol, wherein the individual is advised to adopt self-care measures suitable for flu treatment and is also given an option to schedule a telehealth consultation with a healthcare provider for further evaluation and confirmation of the diagnosis. This intervention reduces system resource utilization, as the user is redirect and does not go instead to a doctor's office to receive assessment and treatment advice.

This example underscores the efficiency of the disclosed system in reducing diagnostic delays, and enhancing patient care responsiveness, and enabling earlier and more timely data processing, among other benefits. By directly extracting and analyzing signals from real-time user interactions, the system proactively identifies potential health concerns, enabling swift and appropriate interventions. This approach not only exemplifies the system's capability to navigate through complex data with precision but also highlights its potential to significantly impact patient care outcomes through timely and accurate health advisories.

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the disclosure is not to be considered as limited by the foregoing description.

Various non-limiting embodiments of the present disclosure will now be described to provide an overall understanding of the principles of the structure, function, and use of systems and methods disclosed herein for data extraction.

Reference to any particular activity is provided in this disclosure only for convenience and not intended to limit the disclosure. A person of ordinary skill in the art would recognize that the concepts underlying the disclosed devices and methods may be utilized in any suitable activity. For example, while the present disclosure is in the context of data extraction, one of ordinary skill would understand the applicability of the described systems and methods to similar tasks in a variety of contexts or environments. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of +10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As used herein, the term “interaction” broadly encompasses any engagement or exchange between two or more entities, which may include, but is not limited to, a user of a system and one or more aspects of the system, such as a chat interface or a provider. This term is intended to cover a wide range of activities where information is exchanged or an effect is produced by one entity on another. For example, in a medical context, an interaction may refer to any contact of a user with the system that generates information, such as the user making a phone call or engaging in a help chat. Further, the term “interaction” may extend to cover medical interactions, such as a user receiving medical services including, but not limited to, consultation, testing, treatment, or the like. These interactions may be classified as either pre-service or post-service based on their occurrence in relation to the primary service event. Accordingly, the data generated from these interactions are referred to as “interaction data,” which may be further categorized into “pre-service interaction data” and “post-service interaction data,” depending on when the data is generated in the course of the user's engagement with the system or service provider. Interaction data thus captures and represents the details and outcomes of the interactions, serving as a basis for further analysis, processing, or decision-making within the system.

As used herein, the term “data signal” refers to a wide range of information pieces or entities that are extracted from the interaction data. In the broadest sense, a data signal can be any piece of information that is deemed relevant or significant within the context of the system's operation or the domain in which it is applied. These signals are typically derived from the raw interaction data through various processing techniques, such as natural language processing, machine learning, or rule-based methods. The purpose of extracting these signals is to distill the most pertinent information from the vast amount of interaction data, thereby facilitating more efficient and effective analysis, decision-making, and action. In the healthcare domain, data signals take on a more specific meaning, referring to clinically relevant information in the form of entity chunks. These signals are extracted from direct interaction data and belong to different umbrella domains of healthcare, such as clinical operations, diseases, provider types, medical contexts, clinical descriptions, and more. For example, a data signal in this context could be a specific diagnosis, a medication name, a procedure code, or a symptom description. These healthcare-specific data signals serve as the foundation for various downstream applications, such as population health management, clinical decision support, quality improvement initiatives, and research. By focusing on these clinically relevant information pieces, the system can provide more targeted and actionable insights that directly contribute to better patient care and overall healthcare outcomes.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

Training the machine-learning model may include one or more machine-learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-Prototypes or K-Means may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc. After training the machine-learning mode, the machine-learning model may be deployed in a computer application for use on new input data that it has not been trained on previously.

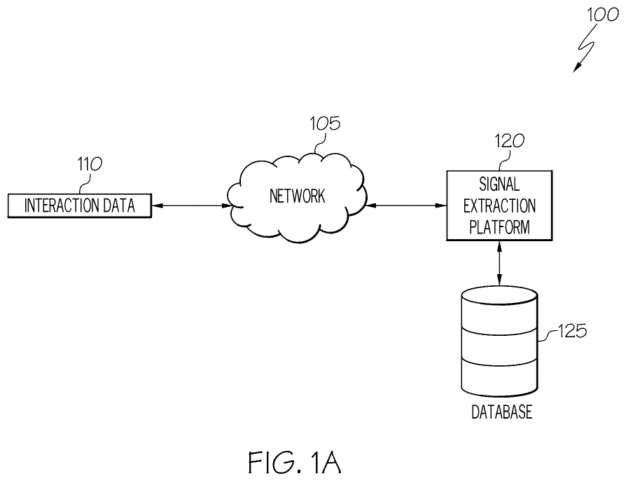

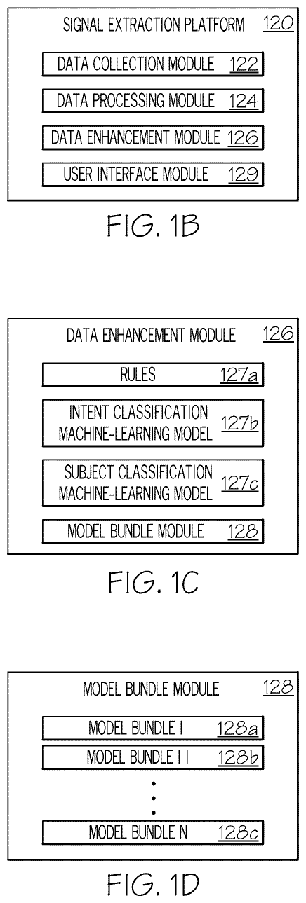

FIG. 1A illustrates a diagram of a system configured for the extraction and analysis of interaction data, in accordance with certain embodiments of the present disclosure. The depicted environment, labeled as environment 100, is consistent with a specific embodiment of this disclosure. Environment 100 encompasses a communication infrastructure termed as network 105, which facilitates connectivity to various interaction data 110 sources, and further integrates with a signal extraction platform 120 that incorporates a comprehensive database 125. This database 125 is structured to store and manage interaction data objects alongside generated intent data objects, subject data objects, and signal data objects, embodying a rich dataset where the data objects represent various aspects of interactions such as intents, subjects, and extracted signals.

In some embodiments, various components within environment 100 interact via network 105. Network 105 facilitates communication between the signal extraction platform 120 and other systems, including one or more systems such as interaction data 110. Interaction data 110 may contain data, data entries, and/or data objects relevant to interaction-related activities within the interaction data integration and analysis environment. Network 105 may encompass various types of networks, including, but not limited to, data networks, wireless networks, telephony networks, or any combination thereof, to support robust and secure data exchange across environment 100. Within environment 100, any of these components, including interaction data 110 sources, signal extraction platform 120, and one or more additional systems, may communicate with one another based on established access permissions.

Any of the interaction data 110 sources, the database 125, and/or one or more other systems associated with the signal extraction platform 120 may contain a diverse collection of structured and/or unstructured data pertinent to user interactions, intents, subjects, and extracted signals. In some embodiments, this data, organized into one or more data objects, spans a variety of dimensions including transcripts of user interactions, intent classifications, subject determinations, extracted signals, API request and response data related to interaction data exchanges, security and compliance documentation, along with insights from interaction data analytics. This extensive repository, which includes interaction records, intent and subject data, extracted signals, and compliance statuses, may be stored in storage solutions that range from local to cloud-based data storage systems, ensuring secure storage and accessibility for ongoing processing and interaction data analytical evaluation.

The database 125 may support the storage and retrieval of data related to one or more datasets and/or data objects, such as interaction data from emails, text messages, call transcripts, as well as health records, intent data objects, subject data objects, signal data objects, and API request and response data related to interaction and health data exchanges. It stores metadata and operational data about entities represented in these datasets, as well as information received from the signal extraction platform 120. Database 125 may comprise systems like a relational database management system (RDBMS), NoSQL database, or graph database, tailored to the specific needs and use cases within environment 100, particularly for managing the complex, interconnected data at the intersection of healthcare and user interactions.

In some embodiments, database 125 may embody any type of database system where data is systematically arranged in structures such as tables, graphs, or other suitable formats. It is configured to store and facilitate retrieval of data utilized by the signal extraction platform 120, encompassing interaction data, health records, data relationships, and platform-generated outcomes. Furthermore, database 125 maintains a vast array of information to aid in the analysis, prediction, and management of health-related outcomes based on insights derived from user interactions within environment 100.

In some embodiments, database 125 comprises a machine learning-based analytics database outlining relationships, associations, and connections between input parameters from interaction data and health records, and output parameters representing interaction-related metrics for intent classification, subject determination, signal extraction, and health outcome prediction. This leverages machine learning algorithms to learn mappings between data inputs (e.g., interaction text, user attributes, health history) and outputs such as intent prediction accuracy, subject classification effectiveness, signal extraction precision, and correlations between interaction signals and health outcomes. This analytics database is periodically updated to incorporate additional insights from ongoing machine learning processes.

Signal extraction platform 120 interacts with other components within network 105 using established or evolving communication protocols. These protocols ensure efficient interactions between nodes and dictate conventions for creating, sending, and interpreting data exchanges across communication links. They operate across different layers, from generating physical signals to facilitating specific software applications engaged in transmitting or receiving interaction data and health information, enabling robust and secure data flow within environment 100 for comprehensive analysis at the intersection of user interactions and healthcare outcomes.

Communications between the various components of the networks are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers.

In operation, environment 100 serves as a platform for processing and analyzing interaction data, utilizing techniques such as data analytics, artificial intelligence, and database management. For instance, in an embodiment, environment 100 facilitates the generation of insights, metrics, and data objects from various datasets, including user interaction data and health records, according to predefined criteria or multiple parameters.

To fulfill these functions, the signal extraction platform 120 may utilize one or more methodologies, such as the deployment of machine-learning models within the data enhancement module 126, specifically configured to analyze interaction data and health records to uncover patterns, trends, and/or anomalies across environment 100. Moreover, the signal extraction platform 120 leverages the data collection module 122 and the data processing module 124 to aggregate and refine interaction-related data, including user intents, interaction subjects, and extracted signals for advanced analysis.

For optimized data storage and retrieval, the database 125 is capable of archiving metadata associated with interaction data and health records, encompassing information on data sources, types, and structures. This database 125 further maintains records on the insights generated by the signal extraction platform 120, such as intent-subject-signal relationships, interaction outcomes, and statistical data on user interactions and their correlation with health-related factors.

Beyond the analysis of interaction data and health records, environment 100 facilitates a variety of applications, from data visualization and search functionalities to predictive modeling. For instance, environment 100 enables healthcare providers or users to query interaction data for specific indicators that match given criteria, such as particular user intents or health-related signals, or to visualize interaction statistics and their correlation with health outcomes through dynamic graphs and charts.

In this manner, environment 100 not only supports the comprehensive analysis of user interactions in the context of healthcare but also enables data-driven decision-making and intervention strategies. By leveraging advanced analytics and machine learning techniques on the rich dataset formed by the intersection of interaction data and health records, the system can uncover one or more insights into user behaviors, preferences, and health-related needs. These insights can then be translated into targeted actions, such as personalized health recommendations, proactive outreach, or resource allocation optimization, ultimately leading to improved health outcomes and enhanced user experiences within the healthcare ecosystem.

FIG. 1B is a diagram illustrating example components of the signal extraction platform 120, in accordance with some embodiments. In some embodiments, signal extraction platform 120, as part of environment 100, is configured to analyze diverse datasets, such as interaction data and health records, and generate data objects, including insights and metrics pertinent to user intents, interaction subjects, and extracted signals. The terms “component” or “module” within this depiction are inclusive of both hardware and software elements implemented via a processor or comparable technology. Notably, the signal extraction platform 120 comprises modules dedicated to the collection, processing, and enhancement of interaction data, as well as the generation of informative data objects. These encompass the data collection module 122, the data processing module 124, the data enhancement module 126, and the user interface module 129. The architecture provides versatility in the configuration of these modules, allowing for the integration of their functions into a consolidated framework or the distribution across various modules with akin functionalities.

In some embodiments, the data collection module 122 of the signal extraction platform 120 is tasked with the acquisition of interaction data from one or more sources and in one or more formats during the functioning of one or more systems of environment 100. This module is configured to manage various data types, including, but not limited to, email conversations, chat transcripts, call recordings, user feedback, other user interactions with one or more systems of environment 100, associated metadata, and the like. It is also configured to handle proprietary or generated data such as interaction analytics, user profiles, and outcomes from predictive modeling based on interaction data.

The interaction data is ingested into the system via multiple pathways, providing flexibility in the collection mechanism for the signal extraction platform 120. One such pathway involves an Application Programming Interface (API) that establishes a secure communication channel for automated data transfer between the data collection module 122 and interaction data 110 sources, enabling real-time and/or batch-based data acquisition. An alternative pathway permits manual input by authorized personnel through a dedicated user interface module 129, where input methods include file uploads or direct data entry into predefined fields. Furthermore, data intake can be facilitated through third-party integrations, middleware, or direct database queries aimed at populating database 125. The data collection module 122 also implements data validation and integrity checks to ensure the accuracy and reliability of the ingested interaction data.

In some embodiments, the data processing module 124 of the signal extraction platform 120 is configured to process and prepare the collected interaction data for further analysis by the data enhancement module 126. The data processing module 124 is configured to augment and/or cleanse the data, removing irrelevant or redundant information, and/or converting the data into a format that is amenable for analysis by the data enhancement module 126. This module is configured to refine the initial data collection, transforming raw, heterogeneous interaction data into a standardized, uniform format for downstream analysis. The data processing module 124 utilizes a variety of algorithms for data standardization, thereby addressing discrepancies in data types, formats, or terminologies emanating from diverse sources.

Additionally, the data processing module 124 incorporates error-handling mechanisms configured to identify and amend potential inaccuracies or anomalies within the interaction data. These mechanisms may include rule-based checks, probabilistic data matching, or data imputation techniques, which are all targeted at preserving the quality and integrity of the data. The data processing module 124 also supports parallel processing capabilities, allowing for the concurrent handling of multiple data streams. This feature is particularly advantageous for processing large volumes of interaction data or enabling real-time analytics.

Upon receiving the processed interaction data from the data processing module 124, the data enhancement module 126 is configured to apply this data within a structured framework configured to facilitate advanced intent classification, subject determination, and signal extraction. This module leverages the capabilities of one or more rules 127a and/or one or more machine learning models, such as the intent classification model 127b and the subject classification model 127c (FIG. 1C), to interpret and analyze the complex relationships in interaction data, including but not limited to user intents, interaction subjects, and extracted signals. The data enhancement module 126 systematically processes the interaction data through these models, enabling the dynamic identification of various interaction-related entities and their interconnections.

In some embodiments, the data enhancement module 126 utilizes an attention-based deep learning architecture to assign variable importance to different aspects of the interaction data, allowing for a understanding of the relationships between user intents, interaction subjects, and extracted signals. Furthermore, the data enhancement module 126 is equipped with machine learning algorithms capable of inferring missing or incomplete information within the interaction data, employing techniques such as data imputation or transfer learning. The data enhancement module 126 is configured to integrate and analyze heterogeneous interaction data sources, from email conversations to call transcripts, by creating a comprehensive, interconnected representation of the data. This integrative approach enables the exploration of potential new correlations and insights into user behaviors, preferences, and needs that may not be evident from isolated data points, and enables predictions of intents and subjects based on the processed interaction data. In some embodiments, the data enhancement module 126 is configured to execute one or more queries and/or one or more modifications against the processed interaction data, facilitating the identification of user intents, determination of interaction subjects, and extraction of relevant signals.

In some embodiments, FIG. 1C illustrates a schematic representation of the data enhancement module 126, according to some embodiments of the disclosure. In some embodiments, the data enhancement module 126 includes one or more rules 127a, intent classification model 127b, a subject classification model 127c, and may include one or more additional components to support one or more operational objectives of the data enhancement module, such as a model bundle module 128.

In some embodiments, rules 127a are a set of predefined guidelines and conditions that govern various aspects of the data enhancement process within the data enhancement module 126. These rules encompass a wide range of functions, including data handling, intent classification, subject identification, and data object generation. For instance, rules 127a may include criteria for classifying conversation types based on specific keywords or patterns, managing format conversions to ensure compatibility with downstream processing, and applying data scrubbing and pre-processing techniques to remove noise and irrelevant information from the interaction data. Additionally, rules 127a may incorporate text standardization and normalization procedures, such as spell checking and case consistency, to improve the quality and uniformity of the processed data. Moreover, rules 127a may define the conditions and thresholds for identifying initial user intents and determining interaction subjects based on predefined categories or taxonomies. These rules may also dictate the structure and layout of the generated data objects, ensuring consistency and facilitating seamless integration with other modules or external systems. Furthermore, rules 127a may specify the criteria for applying specific machine learning models, such as the intent classification model 127b or the subject classification model 127c, based on the characteristics and complexity of the interaction data. Rules 127a may include guidelines for distinguishing between interactions related to current or future needs, enabling proactive engagement and anticipating user requirements.

In some embodiments, the intent classification machine-learning model 127b is configured to predict and categorize user intents based on the processed interaction data. This model leverages advanced techniques from natural language processing, deep learning, and statistical analysis to accurately identify the underlying purpose or goal behind user interactions. The intent classification model 127b is trained on a vast corpus of historical interaction data, which encompasses a wide range of intent categories, such as inquiries, complaints, requests, suggestions, and feedback. Through this training process, the model learns to recognize patterns, linguistic cues, and contextual information that are indicative of specific intents. The model architecture may incorporate state-of-the-art approaches, such as transformer-based networks, recurrent neural networks, or convolutional neural networks, which are capable of capturing complex semantic relationships and dependencies within the interaction data.

Additionally, the intent classification model 127b may employ techniques such as attention mechanisms, which allow the model to focus on the most relevant parts of the interaction data when making intent predictions. The model may also utilize transfer learning, enabling it to adapt and generalize to new intent categories or domains with minimal additional training data. Furthermore, the intent classification model 127b may incorporate domain-specific knowledge and business rules to improve its accuracy and relevance in specific industry contexts. The output of this model is a predicted intent label or a probability distribution over a predefined set of intent categories, which can be further processed by downstream components of the data enhancement module 126, such as the subject classification model 127c or the model bundle module 128.

In some embodiments, the output of the intent classification machine-learning model 127b is an intent data object that encapsulates a comprehensive representation of the user's intent. This intent data object includes one or more components, including a high-level intent indicator and a granular intent indicator. The high-level intent indicator is configured to provide a broad categorization of the user's intent, which offers a general understanding of the interaction's purpose, such as “benefits”, “provider search”, “billing”, “appeal”, or the like. On the other hand, the granular intent indicator is configured to provide specific and detailed aspects of the intent, such as “benefits coverage breakdown”, “cost”, “nearest providers”, “premiums”, or the like. By providing both high-level and granular intent indicators, the intent data object enables a multi-faceted analysis of user interactions, facilitating targeted and precise responses from downstream components of the data enhancement module 126.

The high-level and granular intent indicators in the intent data object are organized in a hierarchical structure, where the granular intents are sub-selections of the high-level intents. This hierarchical relationship allows for a more nuanced understanding of the user's intent, as the granular intents provide specific details within the broader context established by the high-level intents. The intent indicators can be pre-selected based on classifications chosen by a user or domain expert, ensuring alignment with user desires and existing taxonomies. In some embodiments, the intent classification machine-learning model 127b can be trained to generate an identified intent given an interaction data object. Through techniques such as supervised learning and transfer learning, the model learns to recognize patterns and associations within the interaction data, enabling it to derive intents on the fly for previously unseen input data. This flexibility allows the system to adapt to evolving user needs and emerging trends in user interactions.

In some embodiments, the subject classification machine-learning model 127c is configured to identify and categorize the subject of user interactions, specifically the member or individual being discussed during the interaction, based on the processed interaction data. The subject classification model 127c is configured to determine whether the interaction pertains to the caller themselves or if the caller is inquiring on behalf of another person, such as a spouse, child, family member, or someone else. To make this determination, the subject classification model 127c is configured to employ one or more technique from natural language processing, machine learning, and data mining. The subject classification model 127c is trained on a dataset of interaction data, the dataset encompassing various subject categories and member types. During the training process, the subject classification model 127c is configured to learn to recognize patterns, linguistic cues, and contextual information indicative of different subject types and member associations. The subject classification model 127c may be configured to incorporate one or more approach, such as named entity recognition, relationship extraction, or coreference resolution, to identify and link the subject of the interaction to a specific member. Additionally, the subject classification model 127c may be configured to leverage one or more external data source, such as member databases or customer relationship management systems, to enhance its ability to accurately identify and categorize the subject of the interaction. In some embodiments, the subject classification model 127c is further configured to associate the identified member with a corresponding member ID within one or more system of environment 100, enabling seamless integration and data synchronization across multiple platforms. The subject classification model 127c is configured to output a subject data object, which includes the predicted subject type, member identity, and associated member ID, for further processing by one or more downstream component of the data enhancement module 126, such as the model bundle module 128, to guide the selection and application of appropriate signal extraction models tailored to the specific subject and member characteristics.

In some embodiments, FIG. 1D illustrates a schematic representation of the model bundle module 128 according to some embodiments of the disclosure. In some embodiments, the model bundle module 128 is configured to comprise a plurality of model bundles, such as model bundle I 128a, model bundle II 128b, and one or more model bundles n 128c, each model bundle being a grouping of one or more machine learning model specifically trained to extract certain pieces of information from text data based on a predicted granular intent. Each model bundle within the model bundle module 128 may be associated with a specific granular intent, such that the one or more model contained within a given model bundle are configured to be suited for identifying information related to one or more signal within the interaction text data. For example, a model bundle associated with a granular intent related to medical diagnosis may include one or more model configured to extract signals such as specific diseases, symptoms, medications, or medical specialties from the interaction text data. Similarly, a model bundle associated with a granular intent related to customer service inquiries may include one or more model configured to identify signals such as product names, service requests, account information, or customer sentiment. Even further, the model bundles may be tailor or trained specific to individual diseases or categories of diseases. The model bundle module 128 is configured to select and apply the appropriate model bundle based on the predicted granular intent, enabling targeted and efficient extraction of relevant signals from the interaction text data.

In some embodiments, the model bundles within the model bundle module 128 are generated through a training process involving one or more datasets of interaction text data annotated with specific signals and their corresponding granular intents. Each model within a model bundle is configured to learn to recognize patterns, keywords, and contextual cues associated with its targeted signal, while also considering the overall context of the granular intent. The models may be configured to employ various techniques from natural language processing, such as named entity recognition, keyword extraction, or sentiment analysis, to accurately identify and extract the relevant signals from the text data. Additionally, the models within a model bundle may be configured to work in concert, leveraging the outputs and insights from one another to improve the overall accuracy and completeness of the extracted signals. For example, a model focused on extracting medication names may be configured to inform and enhance the performance of a model configured to identify specific diseases or conditions.

In some embodiments, the model bundle module 128 is further configured to continuously update and refine the model bundles based on new interaction data and user feedback. As the system processes more interactions and receives input from users regarding the accuracy and relevance of the extracted signals, the model bundle module 128 is configured to incorporate this information into the training process, allowing the models to adapt and improve over time. This continuous learning process ensures that the model bundles remain up-to-date and effective in handling evolving user needs, language patterns, and domain-specific terminology. Furthermore, the model bundle module 128 may be configured to generate new model bundles or modify existing ones in response to emerging granular intents or changes in the underlying data distribution, ensuring that the system can efficiently extract signals across a wide range of interaction contexts.

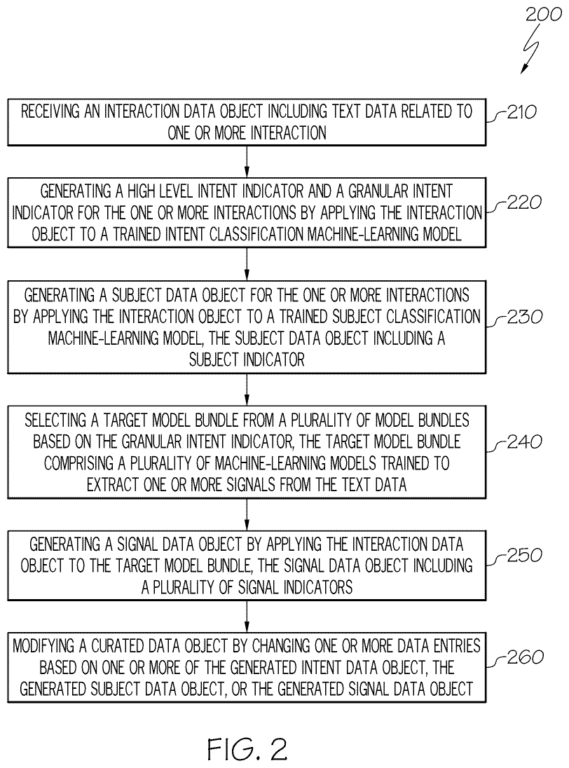

FIG. 2 is a flowchart showing a computer-implemented method 200 for signal extraction from interaction data according to some embodiments of the disclosure. The method 200 is configured to process an interaction data object, which includes text data related to one or more interactions, and output a modified curated data object that has been enriched with insights and signals extracted from the interaction data. In some embodiments, the interaction is a pre-service interaction. The method 200 is performed by the signal extraction platform 120 or the components implemented therein.

In some embodiments, the method 200 for signal extraction is configured to provide several technical benefits and improvements over traditional approaches. By leveraging advanced machine learning techniques, such as intent classification, subject identification, and specialized signal extraction models, the method 200 is configured to enable the automated and efficient processing of large volumes of interaction data in real-time or near-real-time. This allows for the rapid identification of relevant insights and signals, which can be used to inform decision-making, trigger appropriate actions, or optimize various processes. Moreover, the method 200 is configured to handle the complex and unstructured nature of interaction data, such as freeform text or conversational transcripts, extracting meaningful information that may be difficult or time-consuming for humans to identify manually. The use of specialized model bundles tailored to specific granular intents further enhances the accuracy and relevance of the extracted signals, enabling more precise and contextually appropriate actions to be taken based on the insights gleaned from the interaction data.

Additionally, the continuous learning and adaptation of the machine learning models based on new data and user feedback ensures that the method 200 remains effective and up-to-date in the face of evolving interaction patterns, language use, and domain-specific requirements. Overall, the method 200 for signal extraction represents a significant technical advancement in the field of interaction data processing, enabling organizations to harness the full potential of their interaction data and drive more informed, timely, and effective decision-making.

In some embodiments, at step 210, the method 200 includes receiving, by one or more processors, an interaction data object including text data related to one or more interactions. The interaction data object is configured to be a structured representation of the raw interaction data, encapsulating various attributes and metadata associated with the interaction.

In some embodiments, the interaction data object is configured to comprise text data, which may be derived from various sources such as transcripts of voice calls, chat logs, email messages, or social media posts. The text data is configured to capture the natural language content of the interaction, including the words, phrases, and sentences exchanged between the participants. Additionally, the interaction data object may be configured to include metadata such as timestamps, participant identifiers, channel information, or other contextual attributes that provide additional insight into the nature and circumstances of the interaction.

In some embodiments, the interaction data object may be received from various sources, depending on the specific channel or platform through which the interaction occurred. For example, interaction data objects related to voice calls may be received from a call recording system or a speech-to-text transcription service, while those related to chat conversations may be received from a messaging platform API. Similarly, interaction data objects associated with email threads may be received from an email server or a customer support ticketing system. In some cases, the interaction data objects may be retrieved from a database or a data warehouse where they have been previously stored and indexed for efficient access and analysis.

In some embodiments, before being received as an interaction data object, the raw interaction data may undergo various pre-processing steps to convert it into a format suitable for analysis. For instance, voice call recordings may be transcribed using automatic speech recognition techniques to generate a text transcript of the conversation. Similarly, email messages may be parsed to extract the relevant text content, removing any extraneous information such as headers, signatures, or quoted replies. In the case of chat conversations, the individual messages may be concatenated and organized chronologically to create a coherent representation of the interaction. These pre-processing steps are configured to modify one or more entries such that that the interaction data object contains clean, structured, and meaningful text data that can be effectively analyzed by the subsequent components of the method 200, such as the intent classification model 127b and the subject classification model 127c.

In some embodiments, at step 220, the method 200 includes generating, by the one or more processors, an intent data object that includes a high-level intent indicator and a granular intent indicator for the one or more interactions by applying the interaction data object to a trained intent classification machine-learning model 127b. The intent classification machine-learning model 127b is configured to analyze the text data within the interaction data object and predict the underlying intent or purpose of the interaction at both a high level and a more granular, specific level.

In some embodiments, the intent classification machine-learning model 127b is a deep learning model that is specifically configured for processing and understanding natural language data. The model architecture is configured to capture the semantic and contextual information present in the text data, enabling it to accurately infer the intent behind the interaction. The intent classification machine-learning model 127b may be pre-trained on a large corpus of text data, such as Wikipedia articles or news datasets, to develop a general understanding of language and then fine-tuned on a more specific dataset of interaction data with labeled intents to adapt to the particular domain and use case.

In some embodiments, the input to the intent classification machine-learning model 127b is the interaction data object generated in step 210. The text data within the interaction data object is preprocessed and tokenized, converting it into a numerical representation that can be input into the model. This may involve techniques such as word embedding, where each word is mapped to a dense vector that captures its semantic meaning, or more advanced approaches like subword tokenization or character-level encoding.

In some embodiments, the output of the intent classification machine-learning model 127b is an intent data object that includes two components: a high-level intent indicator and a granular intent indicator. The high-level intent indicator provides a broad categorization of the interaction's purpose, such as “inquiry,” “complaint,” “request,” or “feedback.” This high-level classification helps to quickly identify the general nature of the interaction and can be used to route the interaction to the appropriate downstream processes or teams. On the other hand, the granular intent indicator offers a more specific and detailed understanding of the interaction's intent, such as “product information request,” “billing issue,” “account closure request,” or “service quality feedback.”

In some embodiments, the training process for the intent classification machine-learning model 127b involves exposing the model to a large dataset of interaction text data along with corresponding labels for the high-level and granular intents. This dataset is typically curated and annotated by human experts who review each interaction and assign the appropriate intent labels based on a predefined taxonomy or schema. The model learns to recognize patterns and associations between the text data and the intent labels through an iterative process of forward propagation and backpropagation, adjusting its internal parameters to minimize the difference between its predicted intents and the ground-truth labels.

In some embodiments, at step 230, the method 200 includes generating, by the one or more processors, a subject data object for the one or more interactions by applying the interaction data object to a trained subject classification machine-learning model 127c, the subject data object including a subject indicator. The subject classification machine-learning model 127c is configured to analyze the text data within the interaction data object and predict the subject or main topic of the interaction, specifically identifying the individual or entity that the interaction is about. The subject classification machine-learning model 127c may be a machine-learning model, that is trained on a dataset of interaction text data with labeled subject entities.

In some embodiments, the input to the subject classification machine-learning model 127c is the interaction data object, and the output is a subject data object that includes a subject indicator, which may be a specific name, identifier, or category of the individual or entity being discussed in the interaction. The subject classification machine-learning model 127c is configured to learn patterns and features that are associated with different subject types, such as customers, employees, products, or services, and use this knowledge to accurately predict the subject of new, unseen interactions.

In some embodiments, the training process for the subject classification machine-learning model 127c involves iteratively updating the model's parameters based on the error between its predicted subjects and the ground-truth labels, using techniques like gradient descent and backpropagation. The training data for the subject classification machine-learning model 127c is configured to include a diverse range of interaction text data with annotated subject labels, covering various subject types and conversation contexts. The model is configured to learn to generalize from this training data and accurately predict the subjects of new, unseen interactions.

In some embodiments, the subject classification may alternatively or additionally be performed using a rules-based approach, where a set of predefined rules and heuristics are used to extract and categorize the subject entities from the interaction text data based on pattern matching, keyword spotting, or other non-machine learning techniques. The rules-based approach may be used in combination with the machine learning model to improve the overall accuracy and robustness of the subject classification process, or as a fallback method in cases where the machine learning model's confidence in its predictions is low or uncertain. The rules in the rules-based approach are configured to capture common patterns and indicators of subject entities, such as personal names, titles, company names, product names, or service categories, and use these to identify and extract the relevant subject information from the interaction text data. The rules may be manually crafted by domain experts or automatically learned from labeled data using techniques like decision tree induction or association rule mining.

In some embodiments, when the subject of the interaction is determined to be a person or member associated with the system, the subject classification machine-learning model 127c is configured to identify the specific individual based on the information provided in the interaction text data, such as their name, contact details, or other unique identifiers. If the identified subject is the person initiating the interaction, such as the caller or sender, the system is configured to associate the subject with their corresponding member ID, which may be a unique alphanumeric code or other identifier used to track and manage individual members within the system. If the identified subject is someone other than the person initiating the interaction, such as a family member, friend, or colleague that the caller or sender is inquiring about or acting on behalf of, the system is configured to first determine if the mentioned subject is also a member associated with the system, and if so, associate them with their respective member ID. In cases where the mentioned subject is not a registered member, the system may be configured to create a new temporary or provisional member ID for the purpose of tracking and managing the interaction and any associated actions or outcomes.

In some embodiments, at step 240, the method 200 includes selecting, by the one or more processors, a target model bundle from a plurality of model bundles based on the granular intent indicator, the target model bundle comprising a plurality of machine-learning models trained to extract one or more signals from the text data. The target model bundle is a collection of machine learning models that are configured to work together to extract specific types of information or signals from the interaction text data, based on the granular intent of the interaction.

In some embodiments, a target model bundle is a pre-configured package of one or more machine learning models that are trained and optimized for extracting specific types of signals or information from text data, based on a particular granular intent. Each model bundle is configured to include one or multiple individual models, each focusing on a specific aspect or type of signal relevant to the overall intent. For example, a model bundle for a granular intent related to “provider inquiries” may include models for extracting provider names, features, specialties, availability, and customer sentiment, while a model bundle for a granular intent related to “technical support” may include models for extracting problem descriptions, error messages, device specifications, and troubleshooting steps.

In some embodiments, the models within a target model bundle are configured to be modular and interoperable, allowing them to be combined and composed in different ways depending on the specific goals and complexity of the signal extraction task. For example, the output of one model, such as a product name extractor, may be used as input to another model, such as a sentiment analysis model, to provide more context-aware and refined signal extraction. The models may also be configured to share certain layers or components, such as word embeddings or feature extractors, to improve efficiency and reduce redundancy. Further, a target model bundle associated with a granular intent of “symptom reporting” may include models for extracting clinical signals such as specific symptoms (e.g., fever, cough, pain), symptom duration, symptom severity, affected body parts, and other relevant medical information. Similarly, a target model bundle associated with a granular intent of “medication inquiry” may include models for extracting signals such as drug names, dosage, frequency, side effects, and contraindications. The models, in some embodiments, are modular in their bundling as well, such that some models may be included in two or more bundles.

In some embodiments, there is a relationship between the granular intent indicators and the target model bundles. Each granular intent indicator is associated with a specific target model bundle that is configured to and trained to extract the most relevant and useful signals for that particular intent. This mapping between granular intents and model bundles is established based on domain expertise, data analysis, and empirical evaluation, and is stored in a configuration database or lookup table.

In some embodiments, the process for selecting the appropriate target model bundle based on the granular intent indicator involves a lookup or mapping operation. The system is configured to maintain a predefined mapping between granular intent indicators and their corresponding target model bundles, either in a database table, a configuration file, or a hardcoded logic. When a new interaction comes in and its granular intent is determined by the intent classification model, the system simply looks up the associated target model bundle based on this mapping and retrieves it for further processing.

In some embodiments, the selection process may involve additional steps or conditions beyond a simple lookup. For example, there may be multiple target model bundles associated with a single granular intent, each optimized for different scenarios or data characteristics. In such cases, the system may be configured to apply additional selection criteria, such as the language of the interaction, the length or complexity of the text data, or the domain or industry of the customer, to determine the most suitable target model bundle among the candidates. The selection criteria may be predefined rules, heuristics, or learned policies that take into account the relevant features and context of the interaction, and make dynamic, data-driven decisions on the target model bundle selection.

In some embodiments, the system may be configured to employ an ensemble of target model bundles for a given granular intent, where multiple model bundles are selected and applied simultaneously to the interaction text data. The outputs from these multiple model bundles are then aggregated, merged, or weighted to produce the final signal extraction results. The ensemble approach may be used to improve the robustness, accuracy, and coverage of the signal extraction process, by leveraging the diversity and complementarity of different model bundles.

In some embodiments, the use of multiple specialized model bundles offers several advantages over a monolithic, one-size-fits-all approach to signal extraction. By configuring and training model bundles that are optimized for specific granular intents and signal types, the system can achieve higher accuracy, precision, and recall in extracting the relevant information from the interaction text data. The specialized models can learn and leverage the unique patterns, features, and context associated with each granular intent, and avoid the noise, ambiguity, and irrelevance that may arise from a generic model.

In some embodiments, at step 250, the method 200 includes generating, by the one or more processors, a signal data object by applying the interaction data object to the target model bundle, the signal data object including a plurality of signal indicators. The target model bundle, as selected in step 240 based on the granular intent indicator, is configured to include a plurality of specialized machine-learning models that are trained to extract specific types of signals or information from the interaction text data.

In some embodiments, the machine-learning models within the target model bundle are trained using large-scale datasets of annotated interaction text data, where human experts or automated labeling systems have manually labeled the relevant signal indicators and relationships within the text. The models learn to recognize and generalize the patterns, features, and contextual cues that are associated with each type of signal, and can then apply this learned knowledge to extract signals from new, unseen interaction data. The training process may involve various techniques such as supervised learning, semi-supervised learning, or transfer learning, depending on the availability and quality of labeled data for each signal type.

In some embodiments, the input to the target model bundle is the interaction data object, which contains the preprocessed and structured text data from the user interaction. The interaction data object is passed through the different machine-learning models within the target model bundle, each of which is configured to extract a specific type of signal from the text. The models process the text data in parallel or in a sequential pipeline, applying their learned feature extractors, attention mechanisms, and decoding layers to identify and extract the relevant signal entities and relationships.

In some embodiments, the output from the target model bundle is a signal data object, which aggregates and structures the extracted signals from the different models. The signal data object is configured to include a plurality of signal indicators, each of which represents a specific piece of information or insight that has been extracted from the interaction text data. The signal indicators may be organized into predefined categories or fields based on their semantic type, such as “symptom,” “medication,” “duration,” or “severity,” to facilitate downstream processing and analysis.

In some embodiments, the signal data object may also include metadata or confidence scores associated with each signal indicator, reflecting the level of certainty or reliability of the extracted information. The metadata may capture information such as the specific model that extracted the signal, the textual span or context from which the signal was extracted, or any ambiguities or conflicts that were resolved during the extraction process. The confidence scores may be based on factors such as the statistical likelihood of the signal given the input text, the agreement between different models in the target model bundle, or external validation against knowledge bases or expert feedback.

In some embodiments, the training process for the machine-learning models within the target model bundle involves exposing each model to a large dataset of interaction text data that has been annotated with the specific signal types that the model is configured to extract. The training data is carefully curated and preprocessed to ensure high quality and diversity, covering a wide range of interaction scenarios, user demographics, and language variations. The data may be sourced from historical logs of user interactions with the system, such as transcripts of customer support conversations, online chat sessions, or product reviews, and may be augmented with synthetic data generated through techniques like data augmentation, paraphrasing, or machine translation.

In some embodiments, at step 260, the method 200 includes modifying, by the one or more processors, a curated data object by changing one or more data entries based on one or more of the generated intent data object, the generated subject data object, or the generated signal data object. The curated data object, in embodiments, is configured to store and organize structured information related to various healthcare entities, such as patients, interactions, and clinical indicators, and is modified to incorporate the new insights and signals extracted from the user interaction data.

In some embodiments, the curated data object is a database table or a structured file format, such as JSON or XML, that contains multiple data entries, each representing a specific healthcare interaction or patient record. The data entries are organized into predefined fields or attributes, such as “interaction ID,” “member ID,” “subject,” “high-level intent,” “granular intent,” “disease,” “drug,” “provider,” “specialty,” “services required,” “current need,” or the like. These fields are populated with values that are either manually entered by healthcare professionals or automatically extracted from various data sources, including previous patient interactions, medical records, or claims data.

In some embodiments, the modification of the curated data object involves changing one or more data entries based on the information contained in the intent data object, the subject data object, and the signal data object. For example, if the intent data object indicates that the patient's intent is to inquire about a specific medication, the system may modify the curated data object by updating the “drug” field with the extracted medication name, and setting the “granular intent” field to “medication inquiry.” Similarly, if the subject data object identifies the patient as the subject of the interaction, the system may update the “member ID” field with the patient's unique identifier, and link the interaction record to the patient's overall healthcare profile.

In some embodiments, the modification process may involve various types of data entry changes, such as adding a new interaction record, updating an existing patient record, or merging multiple records that refer to the same patient or interaction. The specific type of change is determined based on the nature of the extracted insights and signals, as well as the predefined data model and integrity constraints for the curated data object. For example, if the signal data object contains information about a new diagnosis or treatment plan, the system may create a new data entry for the interaction, and populate it with the relevant clinical indicators and attributes. On the other hand, if the signal data object suggests a change or correction to an existing data entry, the system may update the corresponding fields while maintaining a version history or audit trail.

In some embodiments, the modification of the curated data object involves adding or editing patient characteristics based on the insights derived from the generated data objects. The system may use the intent, subject, and signal data objects to infer additional information about the patient's health status, risk factors, or eligibility for specific treatments or clinical trials. For example, if a patient calls in regarding flu-like symptoms, but the context and language used in the interaction suggest a higher likelihood of COVID-19, the system may modify the curated data object by adding a recommendation for a COVID-19 test, or updating the patient's risk profile to reflect the potential exposure.

In some embodiments, the modification process may involve refining patient eligibility for clinical trials based on the predicted presence or absence of specific conditions. If a patient reports having a condition that is being studied in a clinical trial, but one or more models predict that this is a false positive based on the interaction data and other available information, the system may modify the curated data object by flagging the patient as potentially ineligible for the trial. This can help improve the accuracy and efficiency of patient recruitment for clinical studies, by reducing the number of false positives and focusing on patients who are most likely to benefit from the intervention.

In some embodiments, the system may also use the generated data objects to identify patients who are at risk for certain conditions, even if they are not aware of it themselves. For instance, one or more models predict that a patient has a high risk of heart attack based on their interaction data and other clinical indicators, the system may modify the curated data object by adding a flag or recommendation for further cardiovascular assessment. This information can then be used to proactively reach out to the patient and offer preventive care or enroll them in relevant clinical trials for heart disease.

In some embodiments, the method 200 may further include initiating one or more actions based on the modified curated data object. The specific actions initiated may depend on the nature and content of the modifications made to the curated data object, as well as the predefined business rules and workflows associated with the healthcare system. For example, if the modified curated data object indicates that a patient has reported severe symptoms or a potentially life-threatening condition, the system may automatically initiate an emergency response protocol, which may include dispatching an ambulance, notifying the patient's primary care physician, or sending an alert to the nearest hospital. Similarly, if the modified curated data object suggests that a patient is due for a preventive screening or a follow-up appointment, the system may generate a personalized reminder or scheduling request, and send it to the patient via their preferred communication channel, such as email, text message, or patient portal. Other examples of actions that may be initiated based on the modified curated data object include triggering a prior authorization request for a prescribed medication, initiating a referral to a specialist or a care management program, or generating a risk score or stratification label for the patient. By automating these actions based on the insights and signals extracted from patient interactions, the system can help healthcare organizations to intervene earlier, coordinate care more effectively, and improve patient outcomes while reducing manual effort and delays.

In some embodiments, the method 200 may further include updating the various machine-learning models used in the signal extraction process based on feedback received regarding the accuracy and usefulness of the generated data objects. This feedback may be collected through various channels, such as user surveys, manual reviews by domain experts, or automated comparisons against ground-truth data. For example, the system may periodically send out surveys to a sample of members or healthcare providers who have interacted with the system, asking them to rate the relevance and helpfulness of the intents, subjects, and signals extracted from their interactions. Alternatively, the system may employ human annotators to manually review a subset of the generated data objects and provide detailed feedback on their accuracy and completeness. In some cases, the system may also have access to external data sources, such as electronic health records or claims data, which can serve as a reliable ground truth for evaluating the performance of the machine-learning models. The collected feedback data is then used to fine-tune and improve the machine-learning models through various techniques, such as supervised learning, reinforcement learning, or active learning.

For example, if the feedback data indicates that the intent classification model is consistently misclassifying certain types of intents, the model may be retrained on additional labeled examples of those intents to improve its accuracy. Similarly, if the feedback data suggests that the signal extraction models are missing important clinical information or generating false positives, the models may be updated with more stringent feature selection or filtering criteria. The model updating process may be performed periodically, such as daily, weekly, or monthly, depending on the volume and quality of the feedback data, and may involve various optimization algorithms, such as gradient descent, evolutionary algorithms, or Bayesian optimization, to find the model parameters that balance accuracy and generalization.

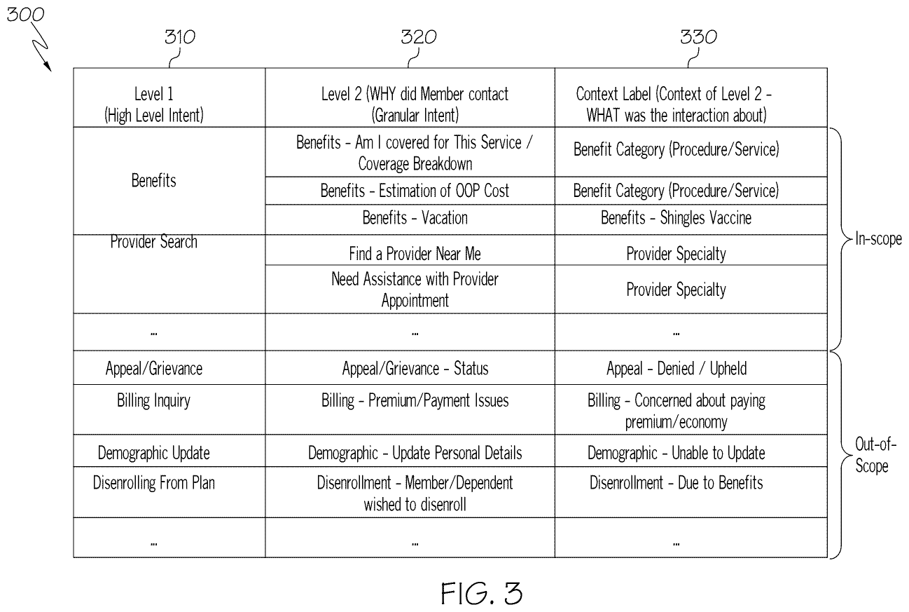

FIG. 3 illustrates an example data object 300 depicting relationships between high-level intents, granular intents, and context labels associated with the granular intents, according to some embodiments of the present disclosure. The data object 300, as shown, is configured as a chart or table comprising three columns: a high-level intent data 310, a granular intent data 320, and a context label data 330. It will be appreciated that the present embodiment is depicted to aid in understanding, and that other formats and structures of the data object 300 are contemplated by this disclosure.

In some embodiments, the high-level intent data 310 is configured to include a plurality of high-level intents, such as “Benefits,” “Provider Search,” “Appeal/Grievance,” “Billing Inquiry,” “Demographic Update,” and “Disenrolling From Plan.” Each high-level intent represents a broad category or topic of the interaction, capturing the overall purpose or goal of the member's inquiry or request.

In some embodiments, the granular intent data 320 is configured to list a plurality of granular intents, each associated with one of the high-level intents in the high-level intent data 310. The granular intents provide a more specific and detailed characterization of the member's intent within the broader high-level category. For example, under the high-level intent “Benefits,” there are three associated granular intents: “Am I covered for this service/Coverage breakdown,” “Estimation of OOP Cost,” and “Vaccination.” Similarly, under the high-level intent “Provider Search,” there are two associated granular intents: “Find Provider Near me” and “Need Assistance with Provider Appointment.” The structure of the data object 300 contemplate and is configure to enable each high-level intent to encompass multiple associated granular intents, providing a hierarchical and multi-level representation of the member's intent.

In some embodiments, the context label data 330 is configured to include a plurality of context labels, each associated with one or more of the granular intents in the granular intent data 320. The context labels provide additional information about the specific context or subject matter of the granular intent, helping to further clarify the nature of the member's inquiry or request. For example, the granular intent “Am I covered for this service/Coverage breakdown” has an associated context label “Benefit Category (Procedure/Service),” indicating that the member is asking about coverage for a specific medical procedure or service. Similarly, the granular intent “Vaccination” has an associated context label “Benefits-Shingle Vaccine,” suggesting that the member is inquiring about coverage for the shingle vaccine specifically. In some embodiments, each high level and/or granular indicator may include one or more context labels.

In data processing and analysis tasks, it is at time advantageous to distinguish between data elements that are considered “in-scope” and those that are deemed “out-of-scope.” In-scope data refers to information that is directly relevant to one or more objects and is likely to contribute meaningful insights or value to the downstream processing and decision-making. Conversely, out-of-scope data encompasses information that is less pertinent to one or more objectives and may not significantly enhance the quality or accuracy of the analysis. The determination of what constitutes in-scope and out-of-scope data can vary depending on the domain, the specific use case, and the goals of the analysis. However, the general principle is to focus on data that is most likely to yield actionable insights while minimizing the inclusion of extraneous or less relevant information that could introduce noise or computational overhead.

In some embodiments, the data object 300 further includes indicators, annotations, flags, or other data entries that designate certain intents as being in-scope or out-of-scope. In-scope intents, such as those related to benefits and provider search, are those that are deemed to have a high likelihood of containing relevant clinical signals and entities that can be extracted and used for downstream analysis and action. On the other hand, out-of-scope intents, such as those related to appeals/grievances, billing inquiries, demographic updates, and plan disenrollment, are those that typically do not involve the exchange of significant clinical information and may be less useful for driving targeted interventions or personalized recommendations.

In some embodiments, the determination of which intents are considered in-scope or out-of-scope may be based on various criteria, such as predefined rules, dynamic rules, or one or more machine learning models. For example, there may be a predefined list of intent categories that are always considered in-scope, based on domain expertise and historical data analysis. Alternatively, the system may employ dynamic rules that adjust the scope classification based on factors such as the specific context labels, the member's historical interactions, or the overall distribution of intents in the data. In some cases, the system may utilize machine learning models, such as decision trees, logistic regression, or neural networks, that are trained on labeled examples of in-scope and out-of-scope intents to automatically classify new intents based on their features and characteristics.

In some embodiments, the high-level intent, granular intent, and context associated with a member's interaction may be determined by applying the interaction data object to one or more machine learning models, as discussed in previous sections. Specifically, the system may first apply the interaction data object to the intent classification model 127b to predict the high-level intent of the interaction, such as “Benefits” or “Provider Search”, and in some embodiments to predict the granular-level intent of the interaction as well. In some embodiments, based on the predicted high-level intent, the system may apply the interaction data object to a one or more additional intent classification models or a set of rules to determine the granular intent within that high-level category, such as “Am I covered for this service/Coverage breakdown” or “Find Provider Near me.” In some embodiments, the system may apply the interaction data object, along with one, both, or neither of the predicted high-level and granular intents, to a context classification model or a set of rules to determine the specific context or subject matter of the interaction, such as “Benefit Category (Procedure/Service)” or “Provider Specialty.” These machine learning models may be trained on large datasets of historical member interactions, where each interaction is labeled with its corresponding high-level intent, granular intent, and context by human annotators or automated labeling systems. The models learn to recognize patterns and features in the interaction data that are predictive of each level of intent and context, and can then generalize this knowledge to classify new, unseen interactions.

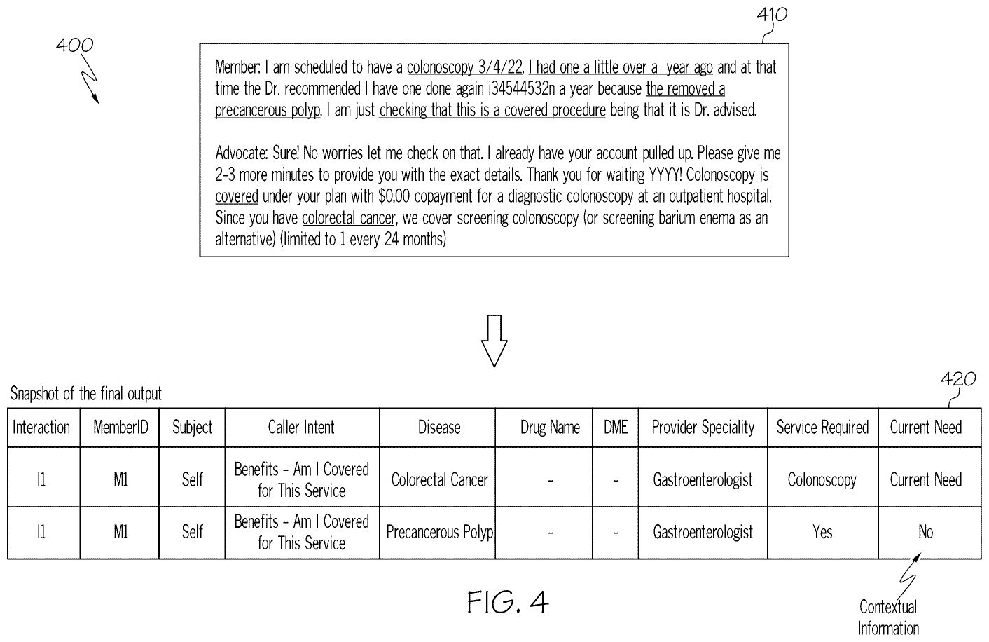

FIG. 4 illustrates an example interaction data object representation 410 and its corresponding extracted signals data object 420, according to some embodiments of the present disclosure. The interaction data object representation 410 is shown as a text transcript of a conversation or interaction between a member and an agent of the system, referred to as an “Advocate.” The advocate may be a human agent, such as a customer service representative or a healthcare professional, or an automated chatbot or virtual assistant.

In some embodiments, the conversation representation 410 captures the natural language exchange between the member and the advocate, including the member's inquiries, requests, or concerns, and the advocate's responses, explanations, or recommendations. The conversation may cover various topics related to the member's healthcare needs, such as benefits coverage, provider search, medication refills, or symptom reporting. The transcript may be generated from various sources, such as audio recordings of phone calls, text logs of chat sessions, or email threads, and may undergo preprocessing steps such as transcription, tokenization, and normalization before being stored as an interaction data object. For example, the shown transcript covers topics related to benefits for colorectal cancer and a previous removal of a precancerous polyp.

In some embodiments, the extracted signals data object 420 is generated by applying the interaction data object representation 410 to one or more signal extraction machine learning models, as described in previous sections in the model bundles. The extracted signals data object 420 is configured as a structured collection of one or more data entries, each representing a specific signal or piece of information that has been extracted from the conversation.

In some embodiments, each data entry in the extracted signals data object 420, such as the first interaction data entry 422 and the second interaction data entry 424, corresponds to a specific interaction or conversation turn within the overall interaction. Each data entry may be associated with a unique interaction ID that serves as a key or index for linking the extracted signals back to their original context in the conversation. Additionally, each data entry may include one or more fields or attributes that capture different aspects or dimensions of the extracted signals, such as the member ID, subject, caller intent, disease, drug name, durable medical equipment, provider, specialty, service request, and an indication of current need.

For example, the first interaction data entry 422 may correspond to a segment of the conversation where the member expresses interest in finding a specialist provider for a specific condition, and the extracted signals may include the member ID, the subject (e.g., “self” or “dependent”), the caller intent (e.g., “Benefits—Am I covered for this service”), the disease or condition (e.g., “Colorectal Cancer”), the provider specialty (e.g., “Gastroenterologist”), a service requested (e.g., “Colonoscopy”), and an indication that this is a current need (e.g., “yes”). Similarly, the second interaction data entry 424 may correspond to a later segment or different intent of the conversation where the member inquires about coverage for a different service, and the extracted signals may include disease name (e.g., “Precancerous Polyp”), the caller intent (e.g., “Benefits—Am I covered for this service”), and an indication that this is a current need (e.g., “no”).

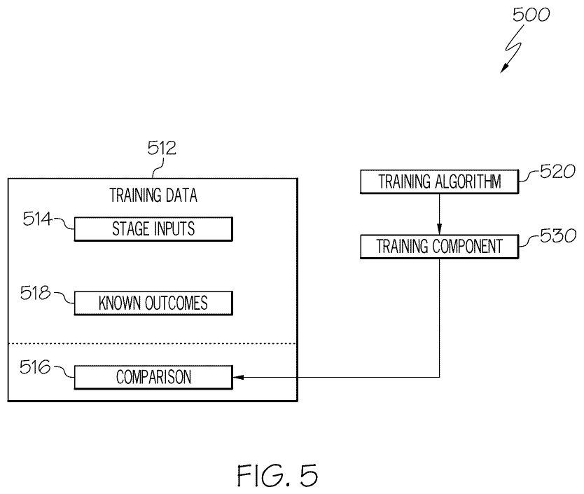

One or more implementations disclosed herein include and/or are implemented using a machine-learning model. For example, one or more of the modules of the condition identification platform 120 are implemented using a machine-learning model and/or are used to train the machine-learning model. FIG. 5 shows an example machine-learning training flow chart, according to some embodiments of the disclosure. Referring to FIG. 5, a given machine-learning model is trained using the training flow chart 500. The training data 512 includes one or more of stage inputs 514 and the known outcomes 518 related to the machine-learning model to be trained. The stage inputs 514 are from any applicable source including text, visual representations, data, values, comparisons, and stage outputs, e.g., one or more outputs from one or more steps from FIG. 2. The known outcomes 518 are included for the machine-learning models generated based on supervised or semi-supervised training, or can based on known labels, such as topic labels. An unsupervised machine-learning model is not trained using the known outcomes 518. The known outcomes 518 includes known or desired outputs for future inputs similar to or in the same category as the stage inputs 514 that do not have corresponding known outputs.

The training data 512 and a training algorithm 520, e.g., one or more of the modules implemented using the machine-learning model and/or are used to train the machine-learning model, is provided to a training component 530 that applies the training data 512 to the training algorithm 520 to generate the machine-learning model. According to an implementation, the training component 530 is provided comparison results 516 that compare a previous output of the corresponding machine-learning model to apply the previous result to re-train the machine-learning model. The comparison results 516 are used by the training component 530 to update the corresponding machine-learning model. The training algorithm 520 utilizes machine-learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Forests and maximum margin methods, the model specifically discussed herein, or the like.

The machine-learning model used herein is trained and/or used by adjusting one or more weights and/or one or more layers of the machine-learning model. For example, during training, a given weight is adjusted (e.g., increased, decreased, removed) based on training data or input data. Similarly, a layer is updated, added, or removed based on training data/and or input data. The resulting outputs are adjusted based on the adjusted weights and/or layers.

In general, any process or operation discussed in this disclosure is understood to be computer-implementable, such as the process illustrated in FIG. 2 are performed by one or more processors of a computer system as described herein. A process or process step performed by one or more processors is also referred to as an operation. The one or more processors are configured to perform such processes by having access to instructions (e.g., software or computer-readable code) that, when executed by one or more processors, cause one or more processors to perform the processes. The instructions are stored in a memory of the computer system. A processor is a central processing unit (CPU), a graphics processing unit (GPU), or any suitable type of processing unit.

A computer system, such as a system or device implementing a process or operation in the examples above, includes one or more computing devices. One or more processors of a computer system are included in a single computing device or distributed among a plurality of computing devices. One or more processors of a computer system are connected to a data storage device. A memory of the computer system includes the respective memory of each computing device of the plurality of computing devices.

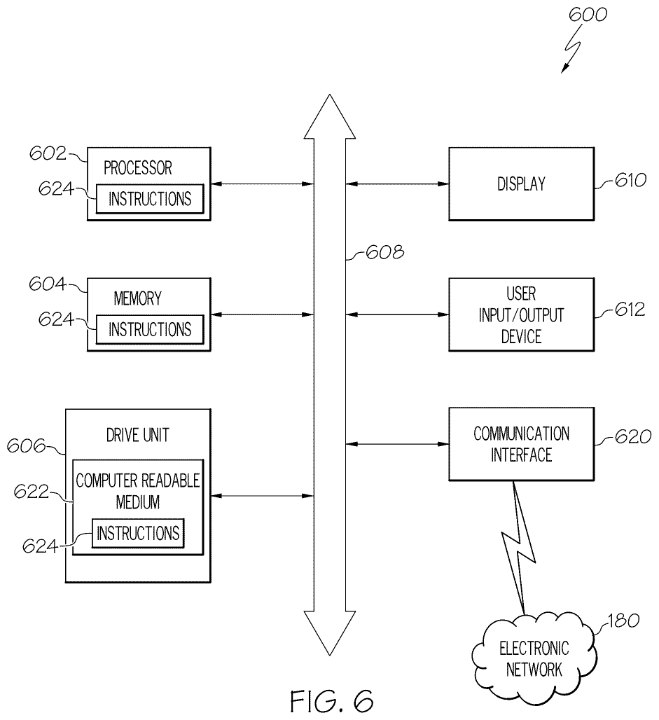

FIG. 6 illustrates an implementation of a computer system that executes techniques presented herein. The computer system 600 includes a set of instructions that are executed to cause the computer system 600 to perform any one or more of the methods or computer based functions disclosed herein. The computer system 600 operates as a standalone device or is connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” refers to any device or portion of a device that processes electronic data, e.g., from registers and/or memory to transform that electronic data into other electronic data that, e.g., is stored in registers and/or memory. A “computer,” a “computing machine,” a “computing platform,” a “computing device,” or a “server” includes one or more processors.

In a networked deployment, the computer system 600 operates in the capacity of a server or as a client user computer in a server-client user environment, or as a peer computer system in a peer-to-peer (or distributed) environment. The computer system 600 is also implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 600 is implemented using electronic devices that provide voice, video, or data communication. Further, while the computer system 600 is illustrated as a single system, the term “system” shall also be taken to include any collection of systems or sub-systems that individually or jointly execute a set, or multiple sets, of instructions to perform one or more computer functions.

As illustrated in FIG. 6, the computer system 600 includes a processor 602, e.g., a central processing unit (CPU), a graphics processing unit (GPU), or both. The processor 602 is a component in a variety of systems. For example, the processor 602 is part of a standard personal computer or a workstation. The processor 602 is one or more processors, digital signal processors, application specific integrated circuits, field programmable gate arrays, servers, networks, digital circuits, analog circuits, combinations thereof, or other now known or later developed devices for analyzing and processing data. The processor 602 implements a software program, such as code generated manually (i.e., programmed).

The computer system 600 includes a memory 604 that communicates via bus 608. The memory 604 is a main memory, a static memory, or a dynamic memory. The memory 604 includes, but is not limited to computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 604 includes a cache or random-access memory for the processor 602. In alternative implementations, the memory 604 is separate from the processor 602, such as a cache memory of a processor, the system memory, or other memory. The memory 604 is an external storage device or database for storing data. Examples include a hard drive, compact disc (“CD”), digital video disc (“DVD”), memory card, memory stick, floppy disc, universal serial bus (“USB”) memory device, or any other device operative to store data. The memory 604 is operable to store instructions executable by the processor 602. The functions, acts, or tasks illustrated in the figures or described herein are performed by the processor 602 executing the instructions stored in the memory 604. The functions, acts, or tasks are independent of the particular type of instruction set, storage media, processor, or processing strategy and are performed by software, hardware, integrated circuits, firmware, micro-code, and the like, operating alone or in combination. Likewise, processing strategies include multiprocessing, multitasking, parallel processing, and the like.

As shown, the computer system 600 further includes a display 610, such as a liquid crystal display (LCD), an organic light emitting diode (OLED), a flat panel display, a solid-state display, a cathode ray tube (CRT), a projector, a printer or other now known or later developed display device for outputting determined information. The display 610 acts as an interface for the user to see the functioning of the processor 602, or specifically as an interface with the software stored in the memory 604 or in the drive unit 606.

Additionally or alternatively, the computer system 600 includes an input/output device 612 configured to allow a user to interact with any of the components of the computer system 600. The input/output device 612 is a number pad, a keyboard, a cursor control device, such as a mouse, a joystick, touch screen display, remote control, or any other device operative to interact with the computer system 600.

The computer system 600 also includes the drive unit 606 implemented as a disk or optical drive. The drive unit 606 includes a computer-readable medium 622 in which one or more sets of instructions 624, e.g. software, is embedded. Further, the sets of instructions 624 embodies one or more of the methods or logic as described herein. The sets of instructions 624 resides completely or partially within the memory 604 and/or within the processor 602 during execution by the computer system 600. The memory 604 and the processor 602 also include computer-readable media as discussed above.

In some systems, computer-readable medium 622 includes the set of instructions 624 or receives and executes the set of instructions 624 responsive to a propagated signal so that a device connected to network 105 communicates voice, video, audio, images, or any other data over the network 105. Further, the sets of instructions 624 are transmitted or received over the network 105 via the communication port or interface 620, and/or using the bus 608. The communication port or interface 620 is a part of the processor 602 or is a separate component. The communication port or interface 620 is created in software or is a physical connection in hardware. The communication port or interface 620 is configured to connect with the network 105, external media, the display 610, or any other components in the computer system 600, or combinations thereof. The connection with the network 105 is a physical connection, such as a wired Ethernet connection, or is established wirelessly as discussed below. Likewise, the additional connections with other components of the computer system 600 are physical connections or are established wirelessly. The network 105 alternatively be directly connected to the bus 608.

While the computer-readable medium 622 is shown to be a single medium, the term “computer-readable medium” includes a single medium or multiple media, such as a centralized or distributed database, and/or associated caches and servers that store one or more sets of instructions. The term “computer-readable medium” also includes any medium that is capable of storing, encoding, or carrying a set of instructions for execution by a processor or that causes a computer system to perform any one or more of the methods or operations disclosed herein. The computer-readable medium 622 is non-transitory, and may be tangible.

The computer-readable medium 622 includes a solid-state memory such as a memory card or other package that houses one or more non-volatile read-only memories. The computer-readable medium 622 is a random-access memory or other volatile re-writable memory. Additionally or alternatively, the computer-readable medium 622 includes a magneto-optical or optical medium, such as a disk or tapes or other storage device to capture carrier wave signals such as a signal communicated over a transmission medium. A digital file attachment to an e-mail or other self-contained information archive or set of archives is considered a distribution medium that is a tangible storage medium. Accordingly, the disclosure is considered to include any one or more of a computer-readable medium or a distribution medium and other equivalents and successor media, in which data or instructions are stored.

In an alternative implementation, dedicated hardware implementations, such as application specific integrated circuits, programmable logic arrays, and other hardware devices, is constructed to implement one or more of the methods described herein. Applications that include the apparatus and systems of various implementations broadly include a variety of electronic and computer systems. One or more implementations described herein implement functions using two or more specific interconnected hardware modules or devices with related control and data signals that are communicated between and through the modules, or as portions of an application-specific integrated circuit. Accordingly, the present system encompasses software, firmware, and hardware implementations.

Computer system 600 is connected to the network 105. The network 105 defines one or more networks including wired or wireless networks. The wireless network is a cellular telephone network, an 802.10, 802.16, 802.20, or WiMAX network. Further, such networks include a public network, such as the Internet, a private network, such as an intranet, or combinations thereof, and utilizes a variety of networking protocols now available or later developed including, but not limited to TCP/IP based networking protocols. The network 105 includes wide area networks (WAN), such as the Internet, local area networks (LAN), campus area networks, metropolitan area networks, a direct connection such as through a Universal Serial Bus (USB) port, or any other networks that allows for data communication. The network 105 is configured to couple one computing device to another computing device to enable communication of data between the devices. The network 105 is generally enabled to employ any form of machine-readable media for communicating information from one device to another. The network 105 includes communication methods by which information travels between computing devices. The network 105 is divided into sub-networks. The sub-networks allow access to all of the other components connected thereto or the sub-networks restrict access between the components. The network 105 is regarded as a public or private network connection and includes, for example, a virtual private network or an encryption or other security mechanism employed over the public Internet, or the like.

In accordance with various implementations of the present disclosure, the methods described herein are implemented by software programs executable by a computer system. Further, in an example, non-limited implementation, implementations can include distributed processing, component/object distributed processing, and parallel processing. Alternatively, virtual computer system processing can be constructed to implement one or more of the methods or functionality as described herein.

Although the present specification describes components and functions that are implemented in particular implementations with reference to particular standards and protocols, the disclosure is not limited to such standards and protocols. For example, standards for Internet and other packet switched network transmission (e.g., TCP/IP, UDP/IP, HTML, and HTTP) represent examples of the state of the art. Such standards are periodically superseded by faster or more efficient equivalents having one or more of the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure is implemented using any appropriate techniques for implementing the functionality described herein. The disclosure is not limited to any particular programming language or operating system.

It should be appreciated that in the above description of example embodiments of the disclosure, various features of the disclosure are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed disclosure requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the instructions for carrying out such a method or element of a method forms a means for carrying out the method or element of a method. Furthermore, an element described herein of an apparatus embodiment is an example of a means for carrying out the function performed by the element for the purpose of carrying out the disclosure.

In the description provided herein, numerous specific details are set forth. However, it is understood that embodiments of the disclosure are practiced without these specific details. In other instances, well-known methods, structures and techniques have not been shown in detail in order not to obscure an understanding of this description.

Thus, while there has been described what are believed to be the preferred embodiments of the disclosure, those skilled in the art will recognize that other and further modifications are made thereto without departing from the spirit of the disclosure, and it is intended to claim all such changes and modifications as falling within the scope of the disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

Example 1. A computer-implemented method comprising; receiving, by one or more processors, an interaction data object including text data related to one or more interaction; generating, by the one or more processors, an intent data object that includes a high level intent indicator and a granular intent indicator for the one or more interactions by applying the interaction data object to a trained intent classification machine-learning model; generating, by the one or more processors, a subject data object for the one or more interactions by applying the interaction data object to a trained subject classification machine-learning model, the subject data object including a subject indicator; selecting, by the one or more processors, a target model bundle from a plurality of model bundles based on the granular intent indicator, the target model bundle comprising a plurality of machine-learning models trained to extract one or more signals from the text data; generating, by the one or more processors, a signal data object by applying the interaction data object to the target model bundle, the signal data object including a plurality of signal indicators; and modifying, by the one or more processors, a curated data object by changing one or more data entries based on one or more of the generated intent data object, the generated subject data object, or the generated signal data object.

Example 2. The computer-implemented method of example 1, wherein each machine-learning model of the plurality of machine-learning models of the target model bundle is trained to extract a unique signal type from the text data related to the one or more interactions.

Example 3. The computer-implemented method of any of examples 1-2, further comprising initiating, by the one or more processors, an action based on the modified curated data object.

Example 4. The computer-implemented method of example 3, wherein initiating an action includes one or more of: applying the modified curated data object to one or more scoring models, generating one or more metrics related to the subject of the one or more interactions, or generating one or more interventions related to the subject of the one or more interactions.

Example 5. The computer-implemented method of any of examples 1-4, further comprising, prior to modifying the curated data object, associating, by the one or more processors, the extracted one or more signals with a user and identifying that one or more signals are indicative of a current need, wherein the modifying of the curated data object occurs upon determination that the one or more signals are indicative of a current need.

Example 6. The computer-implemented method of any of examples 1-5, wherein the intent classification machine-learning model is trained to identify associations between text data and corresponding high level intent indicators and granular intent indicators.

Example 7. The computer-implemented method of any of examples 1-6, wherein the subject classification machine-learning model is trained to identify associations between text data and corresponding subject indicators.

Example 8. The computer-implemented method of any of examples 1-7, wherein the granular intent indicator represents a hierarchical subtopic of the high level intent indicator, and wherein the target model bundle is selected based on the hierarchical subtopic represented by the granular intent indicator.

Example 9. The computer-implemented method of any of examples 1-8, wherein the interaction data object is received from a user interface, and the method further comprises displaying the modified curated data object on the user interface, wherein the displayed modified curated data object includes one or more recommended actions based on the generated signal data object.

Example 10. The computer-implemented method of any of examples 1-9, further comprising updating, by the one or more processors, one or more of the trained intent classification machine-learning model, the trained subject classification machine-learning model, or at least one of the plurality of machine-learning models within the target model bundle based on feedback received regarding an accuracy of the generated intent data object, the generated subject data object, and the generated signal data object, respectively.

Example 11. A system comprising memory and one or more processors communicatively coupled to the memory, the one or more processors configured to: receive an interaction data object including text data related to one or more interactions; generate an intent data object that includes a high level intent indicator and a granular intent indicator for the one or more interactions by applying the interaction data object to a trained intent classification machine-learning model; generate a subject data object for the one or more interactions by applying the interaction data object to a trained subject classification machine-learning model, the subject data object including a subject indicator; select a target model bundle from a plurality of model bundles based on the granular intent indicator, the target model bundle comprising a plurality of machine-learning models trained to extract one or more signals from the text data; generate a signal data object by applying the interaction data object to the target model bundle, the signal data object including a plurality of signal indicators; and modify a curated data object by changing one or more data entries based on one or more of the generated intent data object, the generated subject data object, or the generated signal data object.

Example 12. The system of example 11, wherein each machine-learning model of the plurality of machine-learning models of the target model bundle is trained to extract a unique signal type from the text data related to the one or more interactions.

Example 13. The system of any of examples 11-12, the one or more processors further configured to: initiate an action based on the modified curated data object, wherein initiating an action includes one or more of: applying the modified curated data object to one or more scoring models, generating one or more metrics related to the subject of the one or more interactions, or generating one or more interventions related to the subject of the one or more interactions.

Example 14. The system of any of examples 11-13, the one or more processors further configured to, prior to modifying the curated data object: associate the extracted one or more signals with a user and identifying that one or more signals are indicative of a current need, wherein the modifying of the curated data object occurs upon determination that the one or more signals are indicative of a current need.

Example 15. The system of any of examples 11-14, wherein the intent classification machine-learning model is trained to identify associations between text data and corresponding high level intent indicators and granular intent indicators.

Example 16. The system of any of examples 11-15, wherein the subject classification machine-learning model is trained to identify associations between text data and corresponding subject indicators.

Example 17. The system of any of examples 11-16, wherein the granular intent indicator represents a hierarchical subtopic of the high level intent indicator, and wherein the target model bundle is selected based on the hierarchical subtopic represented by the granular intent indicator.

Example 18. The system of any of examples 11-17, wherein the interaction data object is received from a user interface, and the one or more processors are further configured to: display the modified curated data object on the user interface, wherein the displayed modified curated data object includes one or more recommended actions based on the generated signal data object.

Example 19. The system of any of examples 11-18, the one or more processors further configured to: update one or more of the trained intent classification machine-learning model, the trained subject classification machine-learning model, or at least one of the plurality of machine-learning models within the target model bundle based on feedback received regarding an accuracy of the generated intent data object, the generated subject data object, and the generated signal data object, respectively.

Example 20. One or more non-transitory computer-readable storage media including instructions that, when executed by one or more processors, cause the one or more processors to: receive an interaction data object including text data related to one or more interactions; generate an intent data object that includes a high level intent indicator and a granular intent indicator for the one or more interactions by applying the interaction data object to a trained intent classification machine-learning model; generate a subject data object for the one or more interactions by applying the interaction data object to a trained subject classification machine-learning model, the subject data object including a subject indicator; select a target model bundle from a plurality of model bundles based on the granular intent indicator, the target model bundle comprising a plurality of machine-learning models trained to extract one or more signals from the text data; generate a signal data object by applying the interaction data object to the target model bundle, the signal data object including a plurality of signal indicators; and modify a curated data object by changing one or more data entries based on one or more of the generated intent data object, the generated subject data object, or the generated signal data object.

1. A computer-implemented method comprising;
receiving, by one or more processors, an interaction data object including text data related to one or more interaction;
generating, by the one or more processors, an intent data object that includes a high level intent indicator and a granular intent indicator for the one or more interactions by applying the interaction data object to a trained intent classification machine-learning model;
generating, by the one or more processors, a subject data object for the one or more interactions by applying the interaction data object to a trained subject classification machine-learning model, the subject data object including a subject indicator;
selecting, by the one or more processors, a target model bundle from a plurality of model bundles based on the granular intent indicator, each target model bundle comprising a plurality of machine-learning models trained to extract one or more signals from the text data, wherein each machine-learning model of the plurality of machine-learning models of the target model bundle is trained to extract a unique signal type from the text data related to the one or more interactions;
generating, by the one or more processors, a signal data object by applying the interaction data object to the target model bundle, wherein:
each machine-learning model of the plurality of machine-learning models of the target model bundle is separately applied to the interaction data object to generate a respective output and
the generated signal data object includes a combination of the outputs of the plurality of machine-learning models, the combination being indicative of a particular signal; and
modifying, by the one or more processors, a curated data object by changing one or more data entries based on (i) the generated signal object or (ii) the generated signal object and one or more of the generated intent data object or the generated subject data object.

2. (canceled)

3. The computer-implemented method of claim 1, further comprising initiating, by the one or more processors, an action based on the modified curated data object.

4. The computer-implemented method of claim 3, wherein initiating the action includes one or more of: applying the modified curated data object to one or more scoring models, generating one or more metrics related to the subject of the one or more interactions, or generating one or more interventions related to the subject of the one or more interactions.

5. The computer-implemented method of claim 1, further comprising, prior to modifying the curated data object, associating, by the one or more processors, the extracted one or more signals with a user and identifying that one or more signals are indicative of a current need, wherein the modifying of the curated data object occurs upon determination that the one or more signals are indicative of a current need.

6. The computer-implemented method of claim 1, wherein the intent classification machine-learning model is trained to identify associations between text data and corresponding high level intent indicators and granular intent indicators.

7. The computer-implemented method of claim 1, wherein the subject classification machine-learning model is trained to identify associations between text data and corresponding subject indicators.

8. The computer-implemented method of claim 1, wherein the granular intent indicator represents a hierarchical subtopic of the high level intent indicator, and wherein the target model bundle is selected based on the hierarchical subtopic represented by the granular intent indicator.

9. The computer-implemented method of claim 1, wherein the interaction data object is received from a user interface, and the method further comprises displaying the modified curated data object on the user interface, wherein the displayed modified curated data object includes one or more recommended actions based on the generated signal data object.

10. The computer-implemented method of claim 1, further comprising updating, by the one or more processors, one or more of the trained intent classification machine-learning model, the trained subject classification machine-learning model, or at least one of the plurality of machine-learning models within the target model bundle based on feedback received regarding an accuracy of the generated intent data object, the generated subject data object, and the generated signal data object, respectively.

11. A system comprising:
one or more processors; and
one or more non-transitory computer-readable media storing processor-readable instructions which, when executed by the one or more processors, cause the one or more processors to perform operations including:
receiving an interaction data object including text data related to one or more interactions;
generating an intent data object that includes a high level intent indicator and a granular intent indicator for the one or more interactions by applying the interaction data object to a trained intent classification machine-learning model;
generating a subject data object for the one or more interactions by applying the interaction data object to a trained subject classification machine-learning model, the subject data object including a subject indicator that identifies a person to whom the interaction pertains;
selecting a target model bundle from a plurality of model bundles based on the granular intent indicator, the target model bundle comprising a plurality of machine-learning models trained to extract one or more signals from the text data;
generating a signal data object by applying the interaction data object to the target model bundle, the signal data object including a plurality of signal indicators; and
modifying a curated data object by changing one or more data entries based on one or more of the generated intent data object, the generated subject data object, or the generated signal data object.

12. The system of claim 11, wherein each machine-learning model of the plurality of machine-learning models of the target model bundle is trained to extract a unique signal type from the text data related to the one or more interactions.

13. The system of claim 11, the operations further comprising: initiating an action based on the modified curated data object,
wherein initiating the action includes one or more of:
applying the modified curated data object to one or more scoring models,
generating one or more metrics related to the subject of the one or more interactions, or
generating one or more interventions related to the subject of the one or more interactions.

14. The system of claim 11, the operations further comprising, prior to modifying the curated data object: associating the extracted one or more signals with a user and identifying that one or more signals are indicative of a current need, wherein the modifying of the curated data object occurs upon determination that the one or more signals are indicative of a current need.

15. The system of claim 11, wherein the intent classification machine-learning model is trained to identify associations between text data and corresponding high level intent indicators and granular intent indicators.

16. The system of claim 11, wherein the subject classification machine-learning model is trained to identify associations between text data and corresponding subject indicators.

17. The system of claim 11, wherein the granular intent indicator represents a hierarchical subtopic of the high level intent indicator, and wherein the target model bundle is selected based on the hierarchical subtopic represented by the granular intent indicator.

18. The system of claim 11, wherein the interaction data object is received from a user interface, and the one or more processors are further configured to: display the modified curated data object on the user interface, wherein the displayed modified curated data object includes one or more recommended actions based on the generated signal data object.

19. The system of claim 11, the operations further comprising: updating one or more of the trained intent classification machine-learning model, the trained subject classification machine-learning model, or at least one of the plurality of machine-learning models within the target model bundle based on feedback received regarding an accuracy of the generated intent data object, the generated subject data object, and the generated signal data object, respectively.

20. One or more non-transitory computer-readable storage media including instructions that, when executed by one or more processors, cause the one or more processors to:
receive an interaction data object including text data related to one or more interactions;
generate an intent data object that includes a high level intent indicator and a granular intent indicator for the one or more interactions by applying the interaction data object to a trained intent classification machine-learning model;
generate a subject data object for the one or more interactions by applying the interaction data object to a trained subject classification machine-learning model, the subject data object including a subject indicator that identifies a person to whom the interaction pertains;
select a target model bundle from a plurality of model bundles based on the granular intent indicator, each target model bundle comprising a plurality of machine-learning models trained to extract one or more signals from the text data, wherein each machine-learning model of the plurality of machine-learning models of the target model bundle is trained to extract a unique signal type from the text data related to the one or more interactions;
generate a signal data object by applying the interaction data object to the target model bundle, wherein:
each machine-learning model of the plurality of machine-learning models of the target model bundle is separately applied to the interaction data object to generate a respective output and
the generated signal data object includes a combination of the outputs of the plurality of machine-learning models, the combination being indicative of a particular signal; and
modify a curated data object by changing one or more data entries based on (i) the generated signal object or (ii) the generated signal object and one or more of the generated intent data object or the generated subject data object.
